(19) United States
(12) Patent Application Publication
(10) Pub. No.: US 2020/0040426 A1
(43) Pub. Date: Feb. 6, 2020

(54) A METHOD FOR MANUFACTURING A THERMALLY TREATED STEEL SHEET

(71) Applicant: ArcelorMittal, Luxembourg (LU)

(72) Inventor: Frédéric BONNET, AVRIL (FR)

(21) Appl. No.: 16/469,485

(22) PCT Filed: Dec. 20, 2017
(86) PCT No.: PCT/IB2017/058186

§ 371 Date: Jun. 13, 2019

(30) Foreign Application Priority Data
Dec. 20, 2016 (IB) PCT/IB2016/001786

(51) Int. Cl. C21D 11/00; C21D 9/46; C21D 8/02; C23C 2/06; B32B 15/01

(52) U.S. Cl. CPC C21D 11/005; C21D 9/46; C21D 8/0236; C21D 2211/002; B32B 15/013; C21D 2211/008; C21D 2211/005; C23C 2/06

(57) ABSTRACT

A method for manufacturing a thermally treated steel sheet is described. The method includes:
A. a preparation step including:
   1) a selection substep, wherein the chemical composition and m_{target} are compared to a list of predefined products, which microstructure includes predefined phases and predefined proportion of phases, and selecting a product having a microstructure m_{standard} closest to m_{target} and a predefined thermal path TP_{standard} to obtain m_{standard},
   2) a calculation substep, wherein at least two thermal path TPₓ, each TPₓ corresponding to a microstructure mx obtained at the end of TPₓ, are calculated based on the selected product of step A.1) and TP_{standard} and the initial microstructure mi of the steel sheet to reach m_{target},
   3) an selection substep, wherein one thermal path TP_{target} to reach m_{target} is selected, TP_{target} chosen from TPₓ and selected such that mₓ is the closest to m_{target},
B. a thermal treatment step, wherein TP_{target} is performed on the steel sheet.

### FIELD OF THE INVENTION

The present invention relates to a method for manufacturing a thermally treated steel sheet having a chemical steel composition and a microstructure m_{target} comprising from 0 to 100% of at least one phase chosen among: ferrite, martensite, bainite, pearlite, cementite and austenite, in a heat treatment line. The invention is particularly well suited for the manufacture of automotive vehicles.

### BACKGROUND

It is known to use coated or bare steel sheets for the manufacture of automotive vehicles. A multitude of steel grades are used to manufacture a vehicle. The choice of steel grade depends on the final application of the steel part. For example, IF (Interstitial-Free) steels can be produced for an exposed part, TRIP (Transformation-Induced Plasticity) steels can be produced for seat and floor cross members or A-pillars, and DP (Dual Phase) steels can be produced for rear rails or roof cross members.

During the production of theses steels, crucial treatments are performed on the steel in order to obtain the desired part having expected mechanical properties for one specific application. Such treatments can be, for example, a continuous annealing before deposition of a metallic coating or a quenching and partitioning treatment. Usually, the treatment to perform is selected in a list of known treatments, this treatment being chosen depending on the steel grade.

Patent application WO2010/049600 relates to a method of using an installation for heat treating a continuously moving steel strip, comprising the steps of: selecting a cooling rate of the steel strip depending on, among others, metallurgical characteristics at the entry and metallurgical characteristics required at the exit of the installation; entering the geometric characteristics of the band; calculating power transfer profile along the steel route in the light with the line speed; determining desired values for the adjustment parameters of the cooling section, and adjusting the power transfer of the cooling devices of the cooling section according to said monitoring values.

However, this method is only based on the selection and the application of well-known cooling cycles. It means that for one steel grade, for example TRIP steels, there is a huge risk that the same cooling cycle is applied even if each TRIP steel has its own characteristics comprising chemical composition, microstructure, properties, surface texture, etc. Thus, the method does not take into account the real characteristics of the steel. It allows for the non-personalized heat treatment of a multitude of steel grades.

Consequently, the heat treatment is not adapted to one specific steel and therefore at the end of the treatment, the desired properties are not obtained. Moreover, after the treatment, the steel can have a big dispersion of the mechanical properties. Finally, even if a wide range of steel grades can be manufactured, the quality of the treated steel is poor.

### SUMMARY OF THE INVENTION

An object of various embodiments of the present invention is to solve the above drawbacks by providing a method for manufacturing a thermally treated steel sheet having a specific chemical steel composition and a specific microstructure m_{target} to reach in a heat treatment line. In particular, an object of various embodiments of the present invention is to perform a treatment adapted to each steel sheet, such treatment being calculated very precisely in the lowest calculation time possible in order to provide a steel sheet having the expected properties, such properties having the minimum of properties dispersion possible.

The present invention provides a method for manufacturing a thermally treated steel sheet having a chemical steel composition and a microstructure m_{target} comprising from 0 to 100% of at least one phase chosen among: ferrite, martensite, bainite, pearlite, cementite and austenite, in a heat treatment line comprising:

A. a preparation step comprising:
1) a selection substep, wherein the chemical composition and m_{target} are compared to a list of predefined products, which microstructure includes predefined phases and predefined proportion of phases, and selecting a product having a microstructure m_{standard} closest to m_{target} and a predefined thermal path TP_{standard} to obtain m_{standard},
2) a calculation substep wherein at least two thermal path TPₓ, each TPₓ corresponding to a microstructure mₓ obtained at the end of TPₓ, are calculated based on the selected product of step A.1) and TP_{standard} and the initial microstructure mᵢ of the steel sheet to reach m_{target},
3) an selection substep wherein one thermal path TP_{target} to reach m_{target} is selected, TP_{target} chosen from TPₓ and selected such that mₓ is the closest to m_{target},

B. a thermal treatment step, wherein TP_{target} is performed on the steel sheet.

In some embodiments, the predefined phases in step A.1) are defined by at least one element chosen from: a size, a shape, a chemical and a composition.

In some embodiments, the microstructure m_{target} comprises:

100% of austenite,

from 5 to 95% of martensite, from 4 to 65% of bainite, the balance being ferrite,

from 8 to 30% of residual austenite, from 0.6 to 1.5% of carbon in solid solution, the balance being ferrite, martensite, bainite, pearlite and/or cementite,

from 1% to 30% of ferrite and from 1% to 30% of bainite, from 5 and 25% of austenite, the balance being martensite,

from 5 to 20% of residual austenite, the balance being martensite,

ferrite and residual austenite,

residual austenite and intermetallic phases,

from 80 to 100% of martensite and from 0 to 20% of residual austenite,

100% martensite,

from 5 to 100% of pearlite and from 0 to 95% of ferrite, or

at least 75% of equiaxed ferrite, from 5 to 20% of martensite and bainite in amount less than or equal to 10%.

In some embodiments, said predefined product types comprise Dual Phase, Transformation Induced Plasticity, Quenched & Partitioned, Twins Induced Plasticity, Carbide Free Bainite, Press Hardening Steel, TRIPLEX, DUPLEX and Dual Phase High Ductility steels.

In some embodiments, the differences between proportions of phase present in m_{target} and mₓ is ±3%.

In some embodiments, in step A.2), the thermal enthalpy H released or consumed between mᵢ and m_{target} is calculated such that:

Hₓ=(X_{ferrite}*H_{ferrite})+(Xₘₐᵣₜₑₙₛᵢₜₑ*Hₘₐᵣₜₑₙₛᵢₜₑ)+(X_{bainite}*H_{bainite})+(Xₚₑₐᵣₗᵢₜₑ*Hₚₑₐᵣₗᵢₜₑ)+(H_{cementite}+X_{cementite})+(Hₐᵤₛₜₑₙᵢₜₑ+Xₐᵤₛₜₑₙᵢₜₑ),

X being a phase fraction.

In some embodiments, in step A.2), the all thermal cycle TPₓ is calculated such that:

$$T ( t + Δ t ) = T ( t ) + \frac{( {ϕ}_{Convection} + {ϕ}_{radiance} )}{ρ \cdot Ep \cdot {C}_{pe}} Δ t \pm \frac{{H}_{x}}{{C}_{pe}}$$

with Cpe: the specific heat of the phase (J·kg⁻¹·K⁻¹), ρ: the density of the steel (g·m⁻³), Ep: thickness of the steel (m), φ: the heat flux (convective+radiative in W), Hx (J·Kg⁻¹), T: temperature (° C.) and t: time (s).

In some embodiments, in step A.2), at least one intermediate steel microstructure mₓᵢₙₜ corresponding to an intermediate thermal path TPₓᵢₙₜ and the thermal enthalpy Hₓᵢₙₜ are calculated.

In some embodiments, in step in step A.2), TPₓ is the sum of all TPₓᵢₙₜ and Hₓ is the sum of all Hₓᵢₙₜ.

In some embodiments, before step A.1), at least one targeted mechanical property P_{target} chosen among yield strength YS, Ultimate Tensile Strength UTS, elongation hole expansion, and formability.

In some embodiments, m_{target} is calculated based on P_{target}.

In some embodiments, in step A.2), process parameters undergone by the steel sheet before entering the heat treatment line are taken into account to calculate TPₓ.

In some embodiments, said process parameters comprise at least one element chosen from among: a cold rolling reduction rate, a coiling temperature, a run out table cooling path, a cooling temperature and a coil cooling rate.

In some embodiments, process parameters of the treatment line that the steel sheet will undergo in the heat treatment line are taken into account to calculate TPₓ.

In some embodiments, said process parameters comprise at least one element chosen from among: a specific thermal steel sheet temperature to reach, a line speed, a cooling power of the cooling sections, a heating power of the heating sections, an overaging temperature, a cooling temperature, a heating temperature, and a soaking temperature.

In some embodiments, thermal path, TPₓ, TPₓᵢₙₜ, TP_{standard} or TP_{target}, comprise at least one treatment chosen from: a heating, an isotherm or a cooling treatment.

In some embodiments, every time a new steel sheet enters into the heat treatment line, a new calculation step A.2) is automatically performed based on the selection step A.1) performed beforehand.

In some embodiments, an adaptation of the thermal path is performed as the steel sheet enters into the heat treatment line on the first meters of the sheet.

Another object is achieved by providing a coil made of a steel sheet comprising said predefined product types comprising DP, TRIP, Q&P, TWIP, CFB, PHS, TRIPLEX, DUPLEX and DP HD steels, said steels obtained by a method described above, the coil having a standard variation of mechanical properties below or equal to 25 MPa between any two points along the coil. In some embodiments, a standard variation is below or equal to 15 MPa between any two points along the coil. In some embodiments, a standard variation is below or equal to 9 MPa between any two points along the coil.

The present invention further provides a thermal treatment line adapted for the implementation of the methods described above.

The present invention further provides a computer program product comprising at least a metallurgical module, an optimization module and a thermal module cooperating together to determine TP_{target}, such modules comprising software instructions that when implemented by a computer implement a method according to the embodiments described above.

Other characteristics and advantages of the invention will become apparent from the following detailed description of the invention.

### BRIEF DESCRIPTION OF THE DRAWINGS

To illustrate the invention, various embodiments of non-limiting examples will be described, particularly with reference to the following Figures.

FIG. 1 illustrates an example of an embodiment of a method according to the present invention.

FIG. 2 illustrates an example of an embodiment of the present invention, wherein a continuous annealing of a steel sheet comprising a heating step, a soaking step, a cooling step and an overaging step is performed.

FIG. 3 illustrates an example of an embodiment according to the present invention.

FIG. 4 illustrates an example according to an embodiment of the present invention, wherein a continuous annealing is performed on a steel sheet before the deposition of a coating by hot-dip.

FIG. 5 illustrates an example of an embodiment of the present invention, wherein a quenching and partitioning treatment is performed on a steel sheet.

### DETAILED DESCRIPTION

The following terms will be defined:
CC: chemical composition in weight percent,
m_{target}: targeted value of the microstructure,
m_{standard}: the microstructure of the selected product,
P_{target}: targeted value of a mechanical property,
mᵢ: initial microstructure of the steel sheet,
X: phase fraction in weight percent,
T: temperature in degree Celsius (° C.),
t: time (s),
s: seconds,
UTS: ultimate tensile strength (MPa),
YS: yield stress (MPa),
metallic coating based on zinc means a metallic coating comprising above 50% of zinc,
metallic coating based on aluminum means a metallic coating comprising above 50% of aluminum, and
thermal path, TP_{standard}, TP_{target}, TPₓ and TPₓᵢₙₜ comprise a time, a temperature of the thermal treatment and at least one rate chosen from: a cooling, an isotherm or a heating rate. The isotherm rate has a constant temperature.

The designation “steel” or “steel sheet” means a steel sheet, a coil, a plate having a composition allowing the part to achieve a tensile strength up to 2500 MPa and more preferably up to 2000 MPa. For example, the tensile strength is above or equal to 500 MPa, preferably above or equal to 1000 MPa, advantageously above or equal to 1500 MPa. A wide range of chemical composition is included since the method according to the invention can be applied to any kind of steel.

The present invention provides a method for manufacturing a thermally treated steel sheet having a chemical steel composition and a microstructure m_{target} comprising from 0 to 100% of at least one phase chosen among: ferrite, martensite, bainite, pearlite, cementite and austenite, in a heat treatment line comprising:

A. a preparation step comprising:
1) a selection substep, wherein the chemical composition and m_{target} are compared to a list of predefined products, which microstructure includes predefined phases and predefined proportion of phases, in order to select a product having a microstructure m_{standard} closest to m_{target} and a predefined thermal path TP_{standard} to obtain m_{standard},
2) a calculation substep wherein at least two thermal path TPₓ, each TPₓ corresponding to a microstructure mₓ obtained at the end of TPₓ, are calculated based on the selected product of step A.1) and TP_{standard} and mᵢ to reach m_{target},
3) a selection substep, wherein one thermal path TP_{target} to reach m_{target} is selected, TP_{target} chosen from TPₓ and selected such that mₓ is the closest to m_{target},

B. a thermal treatment step wherein TP_{target} is performed on the steel sheet.

Without willing to be bound by any theory, it seems that when the method according to the present invention is applied, it is possible to obtain a personalized heat treatment for each steel sheet to treat in a short calculation time. Indeed, the method according to various embodiments of the present invention allows for a precise and specific heat treatment which takes into account m_{target}, more precisely the proportion of all the phases along the treatment and mᵢ (including the microstructure dispersion along the steel sheet). Indeed, the method according to various embodiments of the present invention takes into account for the calculation the thermodynamically stable phases, i.e. ferrite, austenite, cementite and pearlite, and the thermodynamic metastable phases, i.e. bainite and martensite. Thus, a steel sheet having the expected properties with the minimum of properties dispersion possible is obtained.

In some embodiments, the microstructure m_{target} to reach comprises: 100% of austenite,

from 5 to 95% of martensite, from 4 to 65% of bainite, the balance being ferrite,

from 8 to 30% of residual austenite, from 0.6 to 1.5% of carbon in solid solution, the balance being ferrite, martensite, bainite, pearlite and/or cementite,

from 1% to 30% of ferrite and from 1% to 30% of bainite, from 5 and 25% of austenite, the balance being martensite,

from 5 to 20% of residual austenite, the balance being martensite,

ferrite and residual austenite,

residual austenite and intermetallic phases,

from 80 to 100% of martensite and from 0 to 20% of residual austenite

100% martensite,

from 5 to 100% of pearlite and from 0 to 95% of ferrite, and

at least 75% of equiaxed ferrite, from 5 to 20% of martensite and bainite in amount less than or equal to 10%.

In some embodiments, during the selection sub step A.1), the chemical composition and m_{target} are compared to a list of predefined products. The predefined products can be any kind of steel grade. For example, they may include Dual Phase DP, Transformation Induced Plasticity (TRIP), Quenched & Partitioned steel (Q&P), Twins Induced Plasticity (TWIP), Carbide Free Bainite (CFB), Press Hardening Steel (PHS), TRIPLEX, DUPLEX and Dual Phase High Ductility (DP HD) steels.

The chemical composition depends on each steel sheet. For example, the chemical composition of a DP steel can comprise:

0.05<C<0.3%,

0.5≤Mn<3.0%,

S≤0.008%,

P≤0.080%,

N≤0.1%,

Si≤1.0%,

the remainder of the composition making up of iron and inevitable impurities resulting from the development.

Each predefined product comprises a microstructure including predefined phases and predefined proportion of phases. In some embodiments, the predefined phases in step A.1) are defined by at least one element chosen from: the size, the shape and the chemical composition. Thus, m_{standard} includes a predefined phase in addition to predefined proportions of phase. In some embodiments, mᵢ, mₓ, m_{target} include phases defined by at least one element chosen from: the size, the shape and the chemical composition. In some embodiments, the predefined product having a microstructure m_{standard} closest to m_{target} is selected as well as thermal path TP_{standard} to reach m_{standard}, m_{standard} comprises the same phases as m_{target}. In some embodiments, m_{standard} also comprises the same phases proportions as m_{target}.

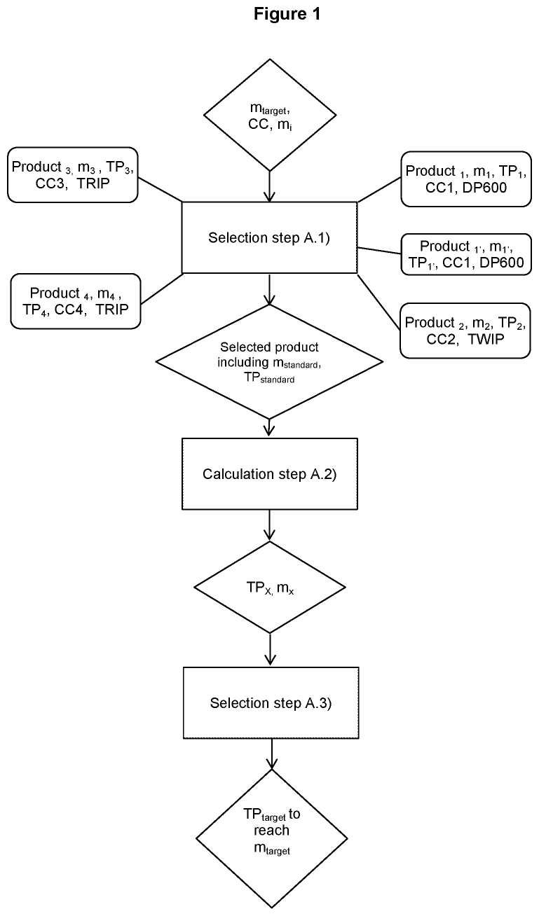

FIG. 1 illustrates an example of an embodiment according to the present invention, wherein the steel sheet to treat has the following CC in weight: 0.2% of C, 1.7% of Mn, 1.2% of Si and of 0.04% Al. m_{target} comprises 15% of residual austenite, 40% of bainite and 45% of ferrite, from 1.2% of carbon in solid solution in the austenite phase. In some embodiments, CC and m_{target} are selected and compared to a list of predefined products chosen from among products 1 to 4. CC and m_{target} correspond to product 3 or 4, such product being a TRIP steel.

Product 3 has the following CC₃ in weight: 0.25% of C, 2.2% of Mn, 1.5% of Si and 0.04% of Al. m₃ comprises 12% of residual austenite, 68% of ferrite and 20% of bainite, from 1.3% of carbon in solid solution in the austenite phase.

Product 4 has the following CC₄ in weight: 0.19% of C, 1.8% of Mn, 1.2% of Si and 0.04% of Al. m₄ comprises 12% of residual austenite, 45% of bainite and 43% of ferrite, from 1.1% of carbon in solid solution in the austenite phase.

Product 4 has a microstructure closest to m_{target} since it has the same phases as m_{target} in the same proportions.

As shown in FIG. 1, two predefined products can have the same chemical composition CC and different microstructures. Indeed, Product₁ and Product_{1′} are both DP600 steels (Dual Phase having an UTS of 600 MPa). One difference is that Product₁ has a microstructure m₁ and Product_{1′} has a different microstructure m_{1′}. The other difference is that Product₁ has a YS of 360 MPa and Product_{1′} has a YS of 420 MPa. Thus, it is possible to obtain steel sheets having different compromise UTS/YS for one steel grade.

During the calculation sub step A.2), at least two thermal paths TPₓ are calculated based on the selected product of step A.1) and mᵢ to reach m_{target}. The calculation of TPₓ takes into account the thermal behavior and metallurgical behavior of the steel sheet when compared to the conventional methods wherein only the thermal behavior is considered. In the example of FIG. 1, product 4 is selected because m₄ is the closest to m_{target} and TP₄ is selected, m₄ and TP₄ corresponding respectively to m_{standard} and TP_{standard}.

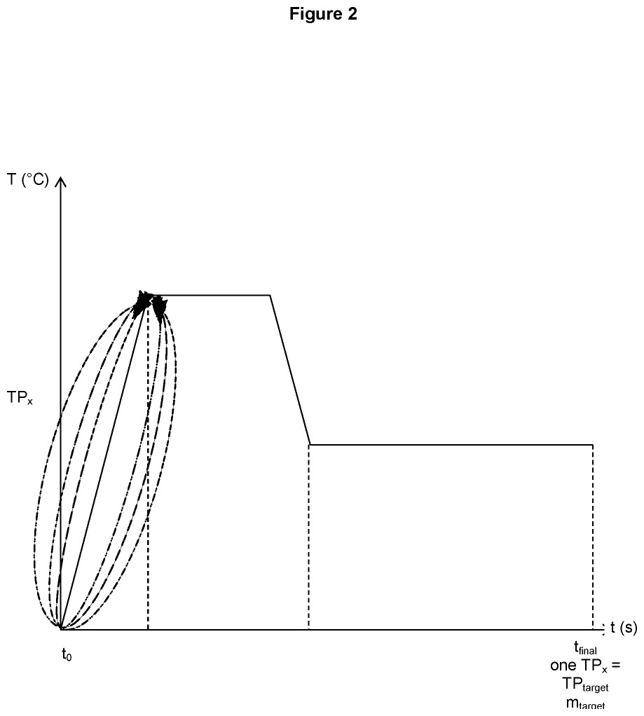

FIG. 2 illustrates a continuous annealing of a steel sheet comprising a heating step, a soaking step, a cooling step and an overaging step. A multitude of TPₓ is calculated to reach m_{target} as shown only for the heating step in FIG. 2. In this example, TPₓ are calculated along the all continuous annealing.

In some embodiments, at least 10 TPₓ are calculated, more preferably at least 50, advantageously at least 100 and more preferably at least 1000. For example, the number of calculated TPₓ is between 2 and 10000, preferably between 100 and 10000, more preferably between 1000 and 10000.

In step A.3), one thermal path TP_{target} to reach m_{target} is selected. TP_{target} is chosen from TPₓ such that m_{X} is the closest to m_{target}. Thus, in FIG. 1, TP_{target} is chosen from a multitude of TPₓ. In some embodiments, the differences between proportions of phase present in m_{target} and mₓ is ±3%.

In some embodiments, in step A.2), the thermal enthalpy H released or consumed between mᵢ and m_{target} is calculated such that:

Hₓ=(X_{ferrite}*H_{ferrite})+(Xₘₐᵣₜₑₙₛᵢₜₑ*Hₘₐᵣₜₑₙₛᵢₜₑ)+(X_{bainite}*H_{bainite})+(Xₚₑₐᵣₗᵢₜₑ*Hₚₑₐᵣₗᵢₜₑ)+(H_{cementite}+X_{cementite})+(Hₐᵤₛₜₑₙᵢₜₑ+Xₐᵤₛₜₑₙᵢₜₑ),

X being a phase fraction.

Without willing to be bound by any theory, H represents the energy released or consumed along the all thermal path when a phase transformation is performed. It is believed that some phase transformations are exothermic and some of them are endothermic. For example, the transformation of ferrite into austenite during a heating path is endothermic whereas the transformation of austenite into pearlite during a cooling path is exothermic.

In some embodiments, in step A.2), the all thermal cycle TPₓ is calculated such that:

$$T ( t + Δ t ) = T ( t ) + \frac{( {ϕ}_{Convection} + {ϕ}_{radiance} )}{ρ \cdot Ep \cdot {C}_{pe}} Δ t \pm \frac{{H}_{x}}{{C}_{pe}}$$

with Cₚₑ: the specific heat of the phase (J·kg⁻¹·K⁻¹), ρ: the density of the steel (g·m³), Ep: the thickness of the steel (m), φ: the heat flux (convective and radiative in W), Hx (J·kg⁻¹), T: temperature (° C.) and t: time (s).

In some embodiments, in step A.2), at least one intermediate steel microstructure mₓᵢₙₜ corresponding to an intermediate thermal path TPₓᵢₙₜ and the thermal enthalpy Hₓᵢₙₜ are calculated. In this case, the calculation of TPₓ is obtained by the calculation of a multitude of TPₓᵢₙₜ. Thus, in some embodiments, TPₓ is the sum of all TPₓᵢₙₜ and Hₓ is the sum of all Hₓᵢₙₜ. In these embodiments, TPₓᵢₙₜ is calculated periodically. For example, it is calculated every 0.5 seconds, preferably 0.1 seconds or less.

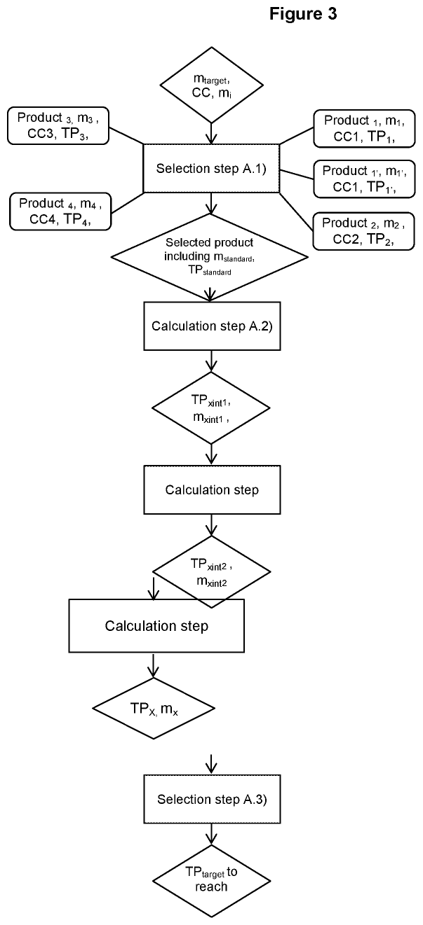

FIG. 3 illustrates an embodiment, wherein in step A.2), mᵢₙₜ₁ and mᵢₙₜ₂ corresponding respectively to TPₓᵢₙₜ₁ and TPₓᵢₙₜ₂ as well as Hₓᵢₙₜ₁ and Hₓᵢₙₜ₂ are calculated. Hₓ during the all thermal path is determined to calculate TPₓ.

In one embodiment, before step A.1), at least one targeted mechanical property P_{target} chosen among yield strength YS, Ultimate Tensile Strength UTS, elongation, hole expansion, formability is selected. In this embodiment, preferably, m_{target} is calculated based on P_{target}.

Without willing to be bound by any theory, it is believed that the characteristics of the steel sheet are defined by the process parameters applied during the steel production. Thus, in some embodiments, in step A.2), the process parameters undergone by the steel sheet before entering the heat treatment line are taken into account to calculate TPₓ. For example, the process parameters comprise at least one element chosen from among: a final rolling temperature, a run out table cooling path, a coiling temperature, a coil cooling rate and cold rolling reduction rate.

In another embodiment, the process parameters of the treatment line that the steel sheet will undergo in the heat treatment line are taken into account to calculate TPₓ. For example, the process parameters comprise at least one element chosen from among: the line speed, a specific thermal steel sheet temperature to reach, heating power of the heating sections, a heating temperature and a soaking temperature, cooling power of the cooling sections, a cooling temperature, an overaging temperature.

In some embodiments, the thermal path, TPₓ, TPₓᵢₙₜ, TP_{standard} or TP_{target} comprise at least one treatment chosen from: a heating, an isotherm or a cooling treatment. For example, the thermal path can be a recrystallization annealing, a press hardening path, a recovery path, an intercritical or full austenitic annealing, a tempering or partitioning path, an isothermal path or a quenching path.

In some embodiments, a recrystallization annealing is performed. The recrystallization annealing comprises optionally a pre-heating step, a heating step, a soaking step, a cooling step and optionally an equalizing step. In this case, it is performed in a continuous annealing furnace comprising optionally a pre-heating section, a heating section, a soaking section, a cooling section and optionally an equalizing section. Without willing to be bound by any theory, it is believed that the recrystallization annealing is the thermal path the more difficult to handle since it comprises many steps to take into account comprising cooling and heating steps.

In some embodiments, every time a new steel sheet enters into the heat treatment line, a new calculation step A.2) is automatically performed based on the selection step A.1) performed beforehand. Indeed, the method according to certain embodiments of the present invention adapts the thermal path TP_{target} to each steel sheet even if the same steel grade enters in the heat treatment line since the real characteristics of each steel often differs. The new steel sheet can be detected and the new characteristics of the steel sheet are measured and are pre-selected beforehand. For example, a detector detects the welding between two coils.

In some embodiments, an adaptation of the thermal path is performed as the steel sheet entries into the heat treatment line on the first meters of the sheet in order to avoid strong process variation.

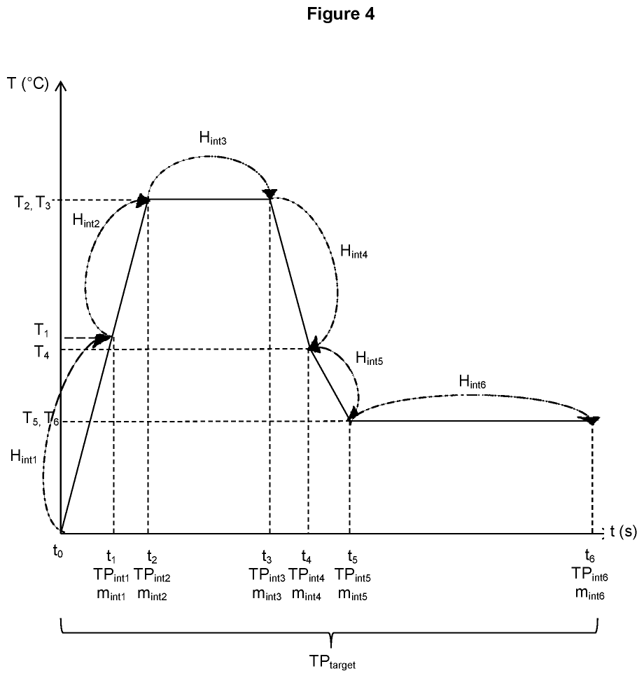

FIG. 4 illustrates an example according to an embodiment of the present invention, wherein a continuous annealing is performed on a steel sheet before the deposition of a coating by hot-dip. With the method according to an embodiment of the present invention, after a selection of a predefined product having a microstructure close to m_{target}, a TPₓ is calculated based on mᵢ, the selected product and m_{target}. In this example, intermediate thermal paths from TPₓᵢₙₜ₁ to TPₓᵢₙₜ₆, corresponding respectively to mₓᵢₙₜ₁ to mₓᵢₙₜ₆, and Hₓᵢₙₜ₁ to Hₓᵢₙₜ₆ are calculated. Hₓ is determined in order to obtain TPₓ. In this Figure, TP_{target} has been selected from a multitude of TPₓ.

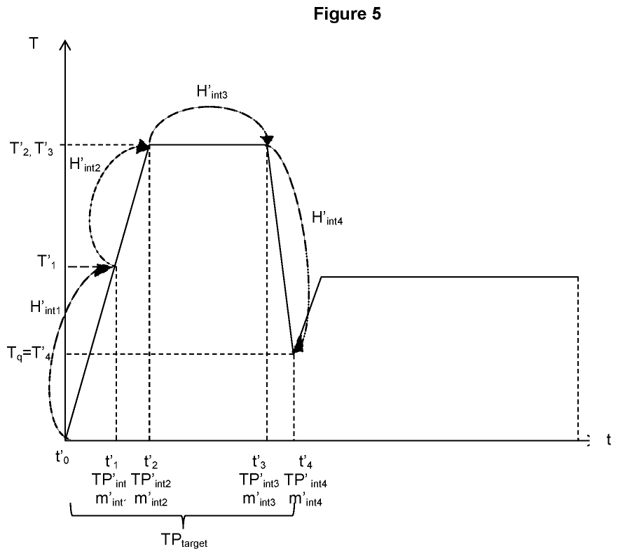

In some embodiments, m_{target} can be the expected microstructure at any time of a thermal treatment. In other words, m_{target} can be the expected microstructure at the end of a thermal treatment as shown in FIG. 4 or at a precise moment of a thermal treatment as shown in FIG. 5. Indeed, for example, for the Q&P steel sheet, an important point of a quenching & partitioning treatment is the T_{q}, corresponding to T′₄ in FIG. 5, which is the temperature of quenching. Thus, the microstructure to consider can be m′_{target}. In this case, after the application of TP′_{target} on the steel sheet, it is possible to apply a predefined treatment.

With the method according to the present invention, it is possible to obtain a coil made of a steel sheet, including said predefined product types, including, e.g., DP, TRIP, Q&P, TWIP, CFB, PHS, TRIPLEX, DUPLEX, DP HD, such coil having a standard variation of mechanical properties below or equal to 25 MPa, preferably below or equal to 15 MPa, more preferably below or equal to 9 MPa, between any two points along the coil. Indeed, without willing to be bound by any theory, it is believed that the method including the calculation step B.1) takes into account the microstructure dispersion of the steel sheet along the coil. Thus, TP_{target} applied on the steel sheet in step B) allows for a homogenization of the microstructure and also of the mechanical properties.

In some embodiments, the mechanical properties are chosen from YS, UTS and elongation. The low value of standard variation is due to the precision of TP_{target}.

In some embodiments, the coil is covered by a metallic coating based on zinc or based on aluminum.

In some embodiments, in an industrial production, the standard variation of mechanical properties between 2 coils made of a steel sheet including said predefined product types including, e.g., DP, TRIP, Q&P, TWIP, CFB, PHS, TRIPLEX, DUPLEX, DP HD, successively produced on the same line is below or equal to 25 MPa, preferably below or equal to 15 MPa, more preferably below or equal to 9 MPa.

A thermally treatment line for the implementation of a method according to the present invention is used to perform TP_{target}. For example, the thermally treatment line is a continuous annealing furnace, a press hardening furnace, a batch annealing or a quenching line.

Finally, the present invention provides a computer program product comprising at least a metallurgical module, an optimization module and a thermal module that cooperate together to determine TP_{target}, such modules comprising software instructions that when implemented by a computer implement the method according to the present invention.

The metallurgical module predicts the microstructure (mₓ, m_{target} including metastable phases: bainite and martensite and stables phases: ferrite, austenite, cementite and pearlite) and more precisely the proportion of phases all along the treatment and predicts the kinetic of phases transformation.

The thermal module predicts the steel sheet temperature depending on the installation used for the thermal treatment, the installation being for example a continuous annealing furnace, the geometric characteristics of the band, the process parameters including the power of cooling, heating or isotherm power, the thermal enthalpy H released or consumed along the all thermal path when a phase transformation is performed.

The optimization module determines the best thermal path to reach m_{target}, i.e. TP_{target} following the method according to the present invention using the metallurgical and thermal modules.

The invention will now be explained in the examples carried out. They are not limiting.

### EXAMPLES

In this example, DP780GI having the following chemical composition was chosen:

| C (%) | Mn (%) | Si (%) | Cr (%) | Mo (%) | P (%) | Cu ( %) | Ti (%) | N (%) |
|---|---|---|---|---|---|---|---|---|
| 0.145 | 1.8 | 0.2 | 0.2 | 0.0025 | 0.015 | 0.02 | 0.025 | 0.06 |

The cold-rolling had a reduction rate of 50% to obtain a thickness of 1 mm.

m_{target} to reach comprised 13% of martensite, 45% of ferrite and 42% of bainite, corresponding to the following P_{target}:YS of 500 MPa and a UTS of 780 MPa. A cooling temperature T_{cooling} of 460° C. had also to be reached in order to perform a hot-dip coating with a zinc bath. This temperature must be reached with an accuracy of +/−2° C. to guarantee good coatability in the Zn bath.

Firstly, the steel sheet was compared to a list of predefined products in order to obtain a selected product having a microstructure m_{standard} closest to m_{target}. The selected product was a DP780GI having the following chemical composition:

| C (%) | Mn (%) | Si (%) |
|---|---|---|
| 0.150 | 1.900 | 0.2 |

The microstructure of DP780GI, i.e., m_{standard}, comprises 10% martensite, 50% ferrite and 40% bainite. The corresponding thermal path TP_{standard} comprises:
a pre-heating step wherein the steel sheet is heated from ambient temperature to 680° C. during 35 seconds,
a heating step wherein the steel sheet is heated from 680° C. to 780° C. during 38 seconds,
soaking step wherein the steel sheet is heated at a soaking temperature T_{soaking} of 780° C. during 22 seconds,
a cooling step wherein the steel sheet is cooled with 11 jets cooling spraying HNₓ as follows:

| Jets | Jet 1 | Jet 2 | Jet 3 | Jet 4 | Jet 5 | Jet 6 | Jet 7 | Jet 8 | Jet 9 | Jet 10 | Jet 11 |
|---|---|---|---|---|---|---|---|---|---|---|---|
| Cooling | 13 | 10 | 12 | 7 | 10 | 14 | 41 | 26 | 25 | 16 | 18 |
| rate | | | | | | | | | | | |
| (° C./s) | | | | | | | | | | | |
| Time (s) | 1.76 | 1.76 | 1.76 | 1.76 | 1.57 | 1.68 | 1.68 | 1.52 | 1.52 | 1.52 | 1.52 |
| T(° C.) | 748 | 730 | 709 | 697 | 681 | 658 | 590 | 550 | 513 | 489 | 462 |
| Cooling | 0 | 0 | 0 | 0 | 0 | 0 | 58 | 100 | 100 | 100 | 100 |
| power(%) | | | | | | | | | | | |

a hot-dip coating in a zinc bath á 460° C.,
the cooling of the steel sheet until the top roll during 24.6 s at 300° C. and
the cooling of the steel sheet at ambient temperature.

Then, a multitude of thermal paths TPₓ were calculated based on the selected product DP780 and TP_{standard} and mᵢ of DP780 to reach m_{target}.

After the calculation of TPₓ, one thermal path TP_{target} to reach m_{target} was selected, TP_{target} being chosen from TPₓ and being selected such that mₓ is the closest to m_{target}. TP_{target} comprises:
a pre-heating step wherein the steel sheet is heated from ambient temperature to 680° C. during 35 seconds,
a heating step wherein the steel sheet is heated from 680° C. to 780° C. during 38 s,
soaking step wherein the steel sheet is heated at a soaking temperature T_{soaking} of 780° C. during 22 seconds,
a cooling step wherein the steel sheet is cooled with 11 jets cooling spraying HNₓ as follows:

| Jets | Jet 1 | Jet 2 | Jet 3 | Jet 4 | Jet 5 | Jet 6 | Jet 7 | Jet 8 | Jet 9 | Jet 10 | Jet 11 |
|---|---|---|---|---|---|---|---|---|---|---|---|
| Cooling | 18 | 11 | 12 | 7 | 38 | 27 | 48 | 19 | 3 | 7 | 6 |
| rate | | | | | | | | | | | |
| (° C./s) | | | | | | | | | | | |
| Time (s) | 1.76 | 1.76 | 1.76 | 1.76 | 1.57 | 1.68 | 1.68 | 1.52 | 1.52 | 1.52 | 1.52 |
| T(° C.) | 748 | 729 | 709 | 697 | 637 | 592 | 511 | 483 | 479 | 468 | 458 |
| Cooling | 0 | 0 | 0 | 0 | 40 | 20 | 100 | 100 | 20 | 20 | 20 |
| power(%) | | | | | | | | | | | |

a hot-dip coating in a zinc bath a 460° C.,
the cooling of the steel sheet until the top roll during 24.6 s at 300° C. and
the cooling of the steel sheet until ambient temperature.

Table 1 shows the properties obtained with TP_{standard} and TP_{target} on the steel sheet:

| | | | Expected |
|---|---|---|---|
| | TP_{standard} | TP_{target} | properties |
| T_{cooling} obtained | 462° C. | 458.09° C. | 460° C. |
| Microstructure | Xₘₐᵣₜₑₙₛᵢₜₑ: 12.83% | Xₘₐᵣₜₑₙₛᵢₜₑ: 12.86% | Xₘₐᵣₜₑₙₛᵢₜₑ: 13% |
| obtained at the | X_{ferrite}: 53.85% | X_{ferrite}: 47.33% | X_{ferrite}: 45% |
| end of the | X_{bainite}: 33.31% | X_{bainite}: 39.82% | X_{bainite}: 42% |
| thermal path | | | |
| Microstructure | Xₘₐᵣₜₑₙₛᵢₜₑ: 0.17% | Xₘₐᵣₜₑₙₛᵢₜₑ: 0.14% | — |
| deviation with | X_{ferrite}: 8.85% | X_{ferrite}: 2.33% | |
| respect to m_{target} | X_{bainite}: 8.69% | X_{bainite}: 2.18% | |
| YS (MPa) | 434 | 494 | 500 |
| YS deviation | 66 | 6 | — |
| with respect to | | | |
| P_{target} (MPa) | | | |
| UTS (MPa) | 786 | 792 | 780 |
| UTS deviation | 14 | 8 | — |
| with respect to | | | |
| P_{target} (MPa) | | | |

Table 1 shows that with the method according to the present invention, it is possible to obtain a steel sheet having the desired expected properties since the thermal path TP_{target} is adapted to each steel sheet. On the contrary, by applying a conventional thermal path, TP_{standard}, the expected properties are not obtained.

1-23. (canceled)

24: A method for manufacturing a thermally treated steel sheet having a chemical steel composition and a microstructure m_{target} comprising from 0 to 100% of at least one phase chosen among: ferrite, martensite, bainite, pearlite, cementite and austenite, in a heat treatment line comprising:
A. a preparation step comprising:
1) a selection substep wherein the chemical composition and m_{target} are compared to a list of predefined products, which microstructure includes predefined phases and predefined proportion of phases, and selecting a product having a microstructure m_{standard} closest to m_{target} and a predefined thermal path TP_{standard} to obtain m_{standard},
2) a calculation substep wherein at least two thermal path TPₓ, each TPₓ corresponding to a microstructure mₓ obtained at the end of TPₓ, are calculated based on the selected product of step A.1) and TP_{standard} and the initial microstructure mᵢ of the steel sheet to reach m_{target},
3) an selection substep wherein one thermal path TP_{target} to reach m_{target} is selected, TP_{target} chosen from TPₓ and selected such that mₓ is the closest to m_{target},
B. a thermal treatment step, wherein TP_{target} is performed on the steel sheet.

25: A method according to claim 24, wherein the predefined phases in step A.1) are defined by at least one element chosen from: a size, a shape, a chemical and a composition.

26: A method according to claim 24, wherein the microstructure m_{target} comprises:
100% of austenite,
from 5 to 95% of martensite, from 4 to 65% of bainite, the balance being ferrite,
from 8 to 30% of residual austenite, from 0.6 to 1.5% of carbon in solid solution, the balance being ferrite, martensite, bainite, pearlite and/or cementite,
from 1% to 30% of ferrite and from 1% to 30% of bainite, from 5 and 25% of austenite, the balance being martensite,
from 5 to 20% of residual austenite, the balance being martensite,
ferrite and residual austenite,
residual austenite and intermetallic phases,
from 80 to 100% of martensite and from 0 to 20% of residual austenite,
100% martensite,
from 5 to 100% of pearlite and from 0 to 95% of ferrite, or
at least 75% of equiaxed ferrite, from 5 to 20% of martensite and bainite in amount less than or equal to 10%.

27: A method according to claim 24, wherein said predefined products comprise Dual Phase, Transformation Induced Plasticity, Quenched & Partitioned, Twins Induced Plasticity, Carbide Free Bainite, Press Hardening Steel, TRIPLEX, DUPLEX and Dual Phase High Ductility steels.

28: A method according to claim 24, wherein the differences between proportions of phase present in m_{target} and mₓ is ±3%.

29: A method according to claim 24, wherein in step A.2), the thermal enthalpy H released or consumed between mᵢ and m_{target} is calculated such that:
Hₓ=(X_{ferrite}*H_{ferrite})+(Xₘₐᵣₜₑₙₛᵢₜₑ*Hₘₐᵣₜₑₙₛᵢₜₑ)+(X_{bainite}*H_{bainite})+(Xₚₑₐᵣₗᵢₜₑ*Hₚₑₐᵣₗᵢₜₑ)+(H_{cementite}+X_{cementite})+(Hₐᵤₛₜₑₙᵢₜₑ+Xₐᵤₛₜₑₙᵢₜₑ),
X being a phase fraction.

30: A method according to claim 29, wherein in step A.2), the all thermal cycle TPₓ is calculated such that:
$$T ( t + Δ t ) = T ( t ) + \frac{( {ϕ}_{Convection} + {ϕ}_{radiance} )}{ρ \cdot Ep \cdot {C}_{pe}} Δ t \pm \frac{{H}_{x}}{{C}_{pe}}$$
with Cpe: the specific heat of the phase (J·kg⁻¹K⁻¹), ρ: the density of the steel (g·m⁻³), Ep: thickness of the steel (m), φ: the heat flux (convective+radiative in W), Hₓ (J·Kg⁻¹), T: temperature (° C.) and t: time (s).

31: A method according to claim 29, wherein in step A.2), at least one intermediate steel microstructure mₓᵢₙₜ corresponding to an intermediate thermal path TPₓᵢₙₜ and the thermal enthalpy Hₓᵢₙₜ are calculated.

32: A method according to claim 31, wherein in step in step A.2), TPₓ is the sum of all TPₓᵢₙₜ and Hₓ is the sum of all Hₓᵢₙₜ.

33: A method according to claim 24, wherein before step A.1), at least one targeted mechanical property P_{target} chosen among yield strength YS, Ultimate Tensile Strength UTS, elongation hole expansion, and formability.

34: A method according to claim 33, wherein m_{target} is calculated based on P_{target}.

35: A method according to claim 24, wherein in step A.2), process parameters undergone by the steel sheet before entering the heat treatment line are taken into account to calculate TPₓ.

36: A method according to claim 35, wherein said process parameters comprise at least one element chosen from among: a cold rolling reduction rate, a coiling temperature, a run out table cooling path, a cooling temperature and a coil cooling rate.

37: A method according to claim 24, wherein process parameters of the treatment line that the steel sheet will undergo in the heat treatment line are taken into account to calculate TPₓ.

38: A method according to claim 37, wherein said process parameters comprise at least one element chosen from among: a specific thermal steel sheet temperature to reach, a line speed, a cooling power of the cooling sections, a heating power of the heating sections, an overaging temperature, a cooling temperature, a heating temperature and a soaking temperature.

39: A method according to claim 24, wherein thermal path, TPₓ, TPₓᵢₙₜ, TP_{standard} or TP_{target}, comprise at least one treatment chosen from: a heating, an isotherm or a cooling treatment.

40: A method according to claim 24, wherein every time a new steel sheet enters into the heat treatment line, a new calculation step A.2) is automatically performed based on the selection step A.1) performed beforehand.

41: A method according to claim 40, wherein an adaptation of the thermal path is performed as the steel sheet enters into the heat treatment line on the first meters of the sheet.

42: A coil made of a steel sheet comprising predefined product types comprising DP, TRIP, Q&P, TWIP, CFB, PHS, TRIPLEX, DUPLEX and DP HD steels, said steels obtained by a method according to claim 24, the coil having a standard variation of mechanical properties below or equal to 25 MPa between any two points along the coil.

43: A coil according to claim 42 having a standard variation below or equal to 15 MPa between any two points along the coil.

44: A coil according to claim 43 having a standard variation below or equal to 9 MPa between any two points along the coil.

45: A thermal treatment line adapted for the implementation of the method according to claim 24.

46: A computer program product comprising at least a metallurgical module, an optimization module and a thermal module cooperating together to determine TP_{target}, such modules comprising software instructions that when implemented by a computer implement a method according to claim 24.
